(19) United States
(12) Patent Application Publication
(10) Pub. No.: US 2022/0407696 A1
(43) Pub. Date: Dec. 22, 2022

(54) SERVER, DATA PROCESSING METHOD, COMPUTER SYSTEM, AND COMPUTER

(71) Applicant: Hitachi, Ltd., Tokyo (JP)

(72) Inventors: Daisuke KITO, Tokyo (JP); Yusuke JIN, Tokyo (JP)

(73) Assignee: Hitachi, Ltd., Tokyo (JP)

(21) Appl. No.: 17/642,039

(22) PCT Filed: Nov. 17, 2020
(86) PCT No.: PCT/JP2020/042837

§ 371 Date: Mar. 10, 2022

(30) Foreign Application Priority Data
Dec. 16, 2019 (JP) 2019-226049

(51) Int. Cl. H04L 9/12; H04L 9/00; H04L 9/40

(52) U.S. Cl. CPC H04L 9/12; H04L 9/50; H04L 63/0407

(57) ABSTRACT

This server having an interface connected to a first computer comprises: a coordination unit that receives a processing request, determines whether a coordination request showing a process for a first blockchain to which the first computer belongs and a process for a second blockchain to which a second computer coordinated to the first computer belongs is included in the processing request, and, if the coordination request is included, determines whether redaction of the coordination request is necessary; and a redaction unit that carries out redaction of the coordination request for which redaction is necessary on the basis of the results of the determination, wherein the coordination unit transmits, to the first computer, a processing execution request that includes the coordination request on which redaction has been carried out by the redaction unit in accordance with the results of the determination.

### CLAIM OF PRIORITY

The present application claims priority from Japanese patent application JP 2019-226049 filed on Dec. 16, 2019, the content of which is hereby incorporated by reference into this application.

### BACKGROUND

This invention relates to a blockchain for sharing various types of data among a plurality of organizations.

The blockchain has such a feature that tampering of data is difficult and direct trade is achieved without intermediary, and has been attracting attention in recent years as application to an infrastructure for cooperate activities in addition to application to virtual currency.

In addition to public blockchains which widely disclose data, there exist private blockchains for sharing data among only members of the same communities. There are expected, for example, a case in which the blockchain is used to manage commercial transactions, such as sharing information on placing and receiving orders of articles in a supply chain, and a case in which the blockchain is used to manage transactions relating to finance, such as sharing settlement information among corporations and users.

While the various blockchains are built in accordance with the applications as described above, a case in which corporate activities continue within each closed blockchain can be considered, but there is a possibility that efficiency of the cooperate activities can be increased more widely by connecting the blockchain to an existing system or by connecting those various blockchains to each other.

When the blockchains are to be connected, it is required to consider an extent of sharing the data. For example, when a blockchain for managing commercial transaction information is caused to cooperate with an existing system or another blockchain for managing financial transaction information, the commercial transaction information may be shared within the blockchain for the commercial transaction, but it is considered that detailed information on settlement, such as a way of the settlement for the commercial transactions (for example, settlement using unique coins or settlement using virtual currency), is intended to be shared among only parties concerned such as members which execute the settlement or are subjects to the settlement.

As a publicly known technology relating to the cooperation in a system which uses blockchains, JP 2017-204070 A is known. According to JP 2017-204070 A, settlement is executed through cooperation between a blockchain for content management and a blockchain for payments.

A user transmits a content request transaction including a payment transaction to the content management blockchain, and a right holder of the content extracts the included payment transaction from data recorded in the content management blockchain, and transmits the payment transaction to the payment blockchain, which is another blockchain, to thereby execute settlement.

### SUMMARY

In the above-mentioned publicly-known technology, not only the transaction relating to articles, but also the transaction relating to the payment are transmitted to and recorded in the content management blockchain, which is the first one of the blockchains. Consequently, there is a problem in that, when a plurality of content right holders exist in the content management blockchain, the content payment information on the user is leaked to other content right holders which are not directly relevant to the user.

In view of the above-mentioned problem, this invention has an object to provide a method with which, when blockchains are caused to cooperate with each other, information is shared among members of a blockchain of a cooperation source while sharing of information on cooperation with another blockchain or system which is not relevant to the blockchain is limited to sharing among only parties concerned.

According to one aspect of the present invention, a server includes, processor, a memory, an interface coupled to a first computer. A cooperation module is configured to receive a processing request, determine whether the processing request includes a cooperation request indicating processing to be applied to a first blockchain to which the first computer belongs and processing to be applied to a second blockchain to which a second computer cooperating with the first computer belongs, and to determine whether concealment of the cooperation request is required when the cooperation request is included. A concealment module is configured to conceal the cooperation request required to be concealed based on a result of the determination. And the cooperation module is configured to transmit, to the first computer, a processing execution request including the cooperation request which has been concealed by the concealment module in accordance with the result of the determination.

According to the at least one embodiment of this invention, when the blockchains are caused to cooperate with each other, the data is shared among the first computers belonging to the first blockchain of the cooperation source, and information which is not relevant to the first blockchain of the cooperation source, or is not intended to be disclosed thereto, such as the information managed by the second blockchain, can be shared among only parties concerned through the concealment.

The details of at least one embodiment of a subject matter disclosed herein are set forth in the accompanying drawings and the following description. Other features, aspects, and effects of the disclosed subject matter become apparent from the following disclosure, drawings, and claims.

### BRIEF DESCRIPTION OF THE DRAWINGS

FIG. 1 is a block diagram for illustrating a hardware configuration and a software configuration of a computer system according to an embodiment of this invention.

FIG. 2 is an explanatory table for showing an example of the program management information according to the embodiment of this invention.

FIG. 3 is an explanatory table for showing an example of the cooperation destination information according to the embodiment of this invention.

FIG. 4A is an example of commercial information recorded in a blockchain ledger according to the embodiment of this invention.

FIG. 4B is an example of payment information recorded in a blockchain ledger according to the embodiment of this invention.

FIG. 4C is an example of transaction information recorded in a blockchain ledger according to the embodiment of this invention.

FIG. 5A is an explanatory table for showing an example of the concealment management information according to the embodiment of this invention.

FIG. 5B is an explanatory table for showing an example of the concealment level information according to the embodiment of this invention. FIG. 5C is an explanatory table for showing an example of the concealment subject information according to the embodiment of this invention.

FIG. 6A is an explanatory table for showing an example of the application destination information according to the embodiment of this invention.

FIG. 6B is an explanatory table for showing an example of the definition of concealment control according to the embodiment of this invention.

FIG. 7 is a flowchart for illustrating an example of determination of whether or not the cooperation and concealment processing for cooperation according to the embodiment of this invention.

FIG. 8 is a flowchart for illustrating an example of determination of whether or not the cooperation and cooperation processing according to the embodiment of this invention.

FIG. 9 is a flowchart for illustrating an example of processing executed by the computer for the cooperation request according to the embodiment of this invention.

FIG. 10 is a flowchart for illustrating processing executed by the computer for the cooperation request received from the computers according to the embodiment of this invention.

### DETAILED DESCRIPTION OF THE PREFERRED EMBODIMENTS

Now, at least one embodiment of this invention is described below with reference to the accompanying drawings. The at least one embodiment described below is given as an example, and are not to limit this invention.

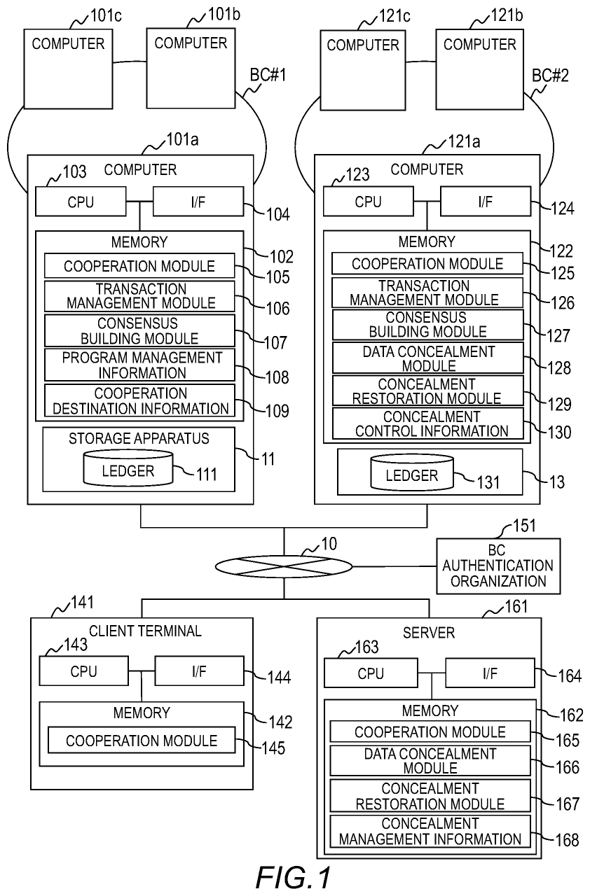

The at least one embodiment is described with reference to FIG. 1 to FIG. 9. FIG. 1 is a block diagram for illustrating a hardware configuration and a software configuration of a computer system according to the at least one embodiment of this invention.

The computer system includes one or more computers 101a to 101c participating in a blockchain BC #1 of a cooperation source, computers 121a to 121c participating in a blockchain BC #2 of a cooperation destination, one or more client terminals 141, one or more servers 161 which receive processing from the client terminals 141, and one or more servers 151 of a blockchain authentication organization (in FIG. 1, “BC authentication organization”)

It should be noted that, when the computers 101a to 101c are not individually identified, reference symbol “101” without a suffix is hereinafter used. The same applies to symbols of other components. Moreover, the computers 101b and 101c have the same configuration as that of the computer 101a. The computers 121b and 121c have the same configuration as that of the computer 121a.

Further, in the at least one embodiment, there is described an example in which a ledger 111 relating to purchase of articles is shared among the computers 101 in the blockchain BC #1 and a ledger 131 relating to payments of money is shared among the computers 121 in the blockchain BC #2, but the information managed by the ledgers 111 and 131 are not limited.

It should be noted that the server 151 of the BC authentication organization is a server 151 which manages information, such as IDs and certificates, for identifying the plurality of blockchains BC #1 and BC #2 existing independently of each other. For example, it is intended that, when the computer 121 of the cooperation destination belonging to the blockchain BC #2 identifies the computer 101 of the blockchain BC #1 of the cooperation source, the computer 121 inquires the server 151, or uses a certificate or the like issued by the server to execute authentication for a legitimate member.

The computers 101 and 121, the servers 151 and 161, and the client terminals 141 are connected to a network 10 via I/Fs 104, 124, 164, and 144, respectively. The computer 101 includes a CPU 103, a memory 102, and I/F 104, and a storage apparatus 11. The CPU 103, for example, receives an operation request from an external device such as the server 161 via the I/F 104 and executes the operation, and transmits a data processing result to the external device.

The memory 102 stores a cooperation module 105, a transaction management module 106, a consensus building module 107, program management information 108, and cooperation destination information 109, and is coupled to the CPU 103 and the I/F 104. The storage apparatus 11 stores the ledger 111 of the blockchain BC #1.

The cooperation module 105, the transaction management module 106, and the consensus building module 107 are loaded as programs onto the memory 102, and are executed by the CPU 103. The CPU 103 executes processing in accordance with the programs of the respective function modules, to thereby operate as the function modules which provide predetermined functions.

For example, the CPU 103 executes processing in accordance with a transaction management program, to thereby function as the transaction management module 106. The same applies to other programs. Moreover, the CPU 103 also operates as functional modules which provide respective functions of a plurality of pieces of processing executed by each program. The computer and the computer system are an apparatus and a system including those function modules. The same applies to the another computers 121 and CPUs 163 of the servers 161.

The computer 121 includes a CPU 123, a memory 122, the I/F 124, and a storage apparatus 13. The CPU 123, for example, receives an operation request from an external device such as the server 161 via the I/F 124 and executes the operation, and transmits a data processing result to the external device.

The memory 122 stores a cooperation module 125, a transaction management module 126, a consensus building module 127, a data concealment module 128, a concealment restoration module 129, and concealment control information 130, and is coupled to the CPU 123 and the I/F 124. The storage apparatus 13 stores the ledger 131 of the blockchain BC #2.

The transaction management module 126, the consensus building module 127, the data concealment module 128, and the concealment restoration module 129 are loaded as programs onto the memory 122, and are executed by the CPU 123. The server 161 includes the CPU 163, a memory 162, and the I/F 164. The

CPU 163, for example, transmits operation requests to the computers 101 and the like, and receives operation results from the computers 101 and the like via the I/F 164. The memory 162 stores a cooperation module 165, a data concealment module 166, a concealment restoration module 167, and concealment management information 168, and is coupled to the CPU 163 and the I/F 164.

The cooperation module 165, the data concealment module 166, and the concealment restoration module 167 are loaded as programs onto the memory 162, and are executed by the CPU 163.

The client terminal 141 includes a CPU 143, a memory 142, and the I/F 144. The CPU 143, for example, transmits operation requests to the servers 161 and the like, and receives operation results from the servers 161 and the like via the I/F 144. The memory 142 stores a cooperation module 145, and is connected to the CPU 143 and the

I/F 144. The cooperation module 145 is loaded as a program onto the memory 142, and is executed by the CPU 143.

Description is now given of details (the information stored in the memory 102, the memory 122, the memory 162, and the memory 142) of the software configuration of the computer system according to the at least one embodiment.

The information (the program management information 108 and the cooperation destination information 109) other than the programs stored in the memory 102 is first described, and, after that, the program information (information on the modules 105 to 107) stored in the memory 102 is described. The program management information 108 is information to be used by the computer 101 to determine whether processing requested by the server 161 or the like is processing in which a program to be executed is closed within the own blockchain BC #1, such as update of the ledger 111 within the blockchain BC #1 or communication to/from the another computer 101 within the own blockchain BC #1, or is processing which is also relevant to the another blockchain BC #2, such as a request for processing to be applied to the another blockchain BC #2.

In the processing executed in the computer system according to the at least one embodiment, the client terminal 141 first transmits a processing request to the server 161. The processing request includes a processing request directed to the blockchain BC #1, and includes a cooperation request relating to the blockchain BC #2 in accordance with a content of the processing.

In the blockchain BC #1, for example, information on logistics relating to purchase of articles is managed. Moreover, in the blockchain BC #2, information on finance relating to payments is managed. The client terminal 141 issues a cooperation request by adding the processing request thereto when a payment is to be settled in addition to purchase of an article.

The client terminal 141 in the at least one embodiment issues a processing request not including a cooperation request in a case of only the purchase of an article, and issues a processing request including a cooperation request in a case of the settlement of a payment in addition to the purchase of an article.

When the server 161 receives the processing request from the client terminal 141, the server 161 determines whether or not a cooperation request is included in the processing request as described below. When a cooperation request is included in the processing request, the server 161 determines whether or not the cooperation request is to be concealed as described below. When it is determined that the concealment is required, the server 161 conceals the cooperation request.

After that, the server 161 transmits, as a processing execution request, a processing request including the cooperation request which has been concealed as required to the computers 101 belonging to the blockchain BC #1.

The computer 101 determines whether or not the processing execution request received from the server 161 includes a cooperation request. When a cooperation request is included, the computer 101 transmits the cooperation request to the computers 121 belonging to the blockchain BC #2.

The computer 101 processes the processing request, and when the processing request includes a cooperation request, the computer 101 transmits the cooperation request to the computers 121 of the blockchain BC #2 to cause the computers 121 to process the cooperation request. The computer 121 processes the cooperation request as described below, and a processing result of the cooperation request is concealed as required, and is then transmitted to the computers 101.

When the computer 101 receives the results of the processing for the cooperation request in the blockchain BC #2, the computer 101 transmits a processing result of the processing request and the processing results of the cooperation request to the server 161.

When the processing results of the cooperation request have been concealed, the server 161 restores (decrypts) the processing results, and transmits the restored processing results of the cooperation request and the processing result of the processing request to the client terminal 141 and finishes the series of steps of processing.

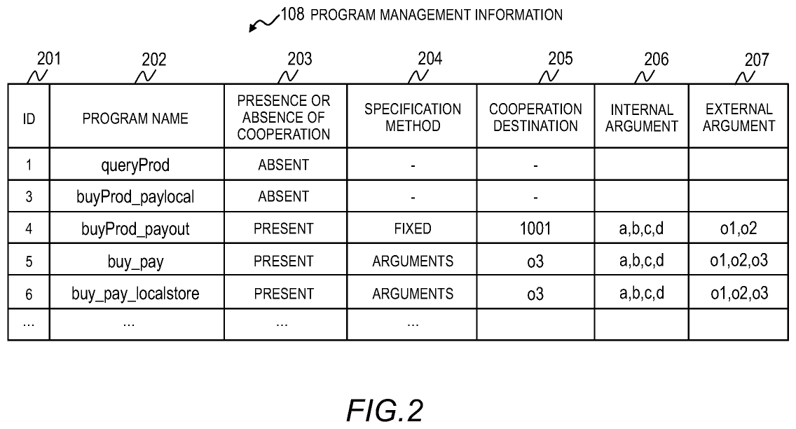

FIG. 2 is an explanatory table for showing an example of the program management information 108 in the at least one embodiment of this invention. This information includes seven data items of an item 201 to an item 207 in one entry.

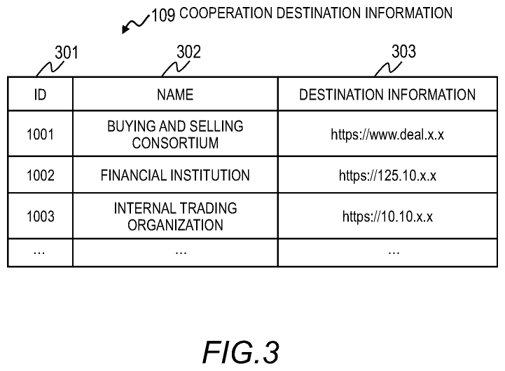

The item 201 indicates ID information for identifying a program managed by the computer 101. The item 202 indicates a name of the program. The item 203 indicates whether or not this program cooperates with an external system such as the external blockchain BC #2. The item 204 indicates whether a system of a cooperation destination provides fixed processing or processing to be executed can be selected through use of arguments or the like from the client terminal 141 or the like. When the item 204 is “arguments,” processing can be selected in accordance with arguments used for the execution, and the item 204 indicates fixed processing otherwise. The item 205 indicates detailed information on an apparatus of the cooperation destination obtained by referring to the cooperation destination information 109 described below or the like. For example, in the example of FIG. 2, information of “1001” indicates a cooperation destination having “1001” as an ID of the cooperation destination information 109 of FIG. 3 described below. Information of “o3” means that an argument o3 specified by the server 161 indicates a cooperation destination.

The item 206 indicates which of arguments specified by the server 161 is relevant to the own blockchain BC #1. The item 207 indicates which of arguments specified by the server 161 relates to the cooperation destination which is not directly relevant to the own blockchain BC #1. For example, in FIG. 2, when the value of the ID of the item 201 is “5,” arguments “a, b, c, d, o1, o2, and o3” including internal arguments and external arguments are received from the server 161. Of those arguments, the computer 101 uses only the internal arguments “a, b, c, and d” as arguments relevant to the own blockchain BC #1 to refer to and update the data of the own blockchain BC #1. Moreover, the computer 101 transmits the external arguments “o1, o2, and o3” to the blockchain BC #2 of the cooperation destination.

FIG. 3 is an explanatory table for showing an example of the cooperation destination information 109 in the at least one embodiment of this invention. This information includes three data items of an item 301 to an item 303 in one entry. The item 301 indicates ID information for identifying each cooperation destination. The item 302 indicates a name of the cooperation destination. The item 303 indicates detailed information on the cooperation destination, such as an IP address of the cooperation destination.

The program information stored in the memory 102 is now described. First, the cooperation module 105 communicates data to/from the computers 101 belonging to the own blockchain BC #1, the computers 121 belonging to the another blockchain BC #2, the client terminals 141, and the like. The transaction management module 106 manages information on a transaction, such as writing or reference to the ledger 111, for a processing request received from the server 161 and the like, and executes this transaction.

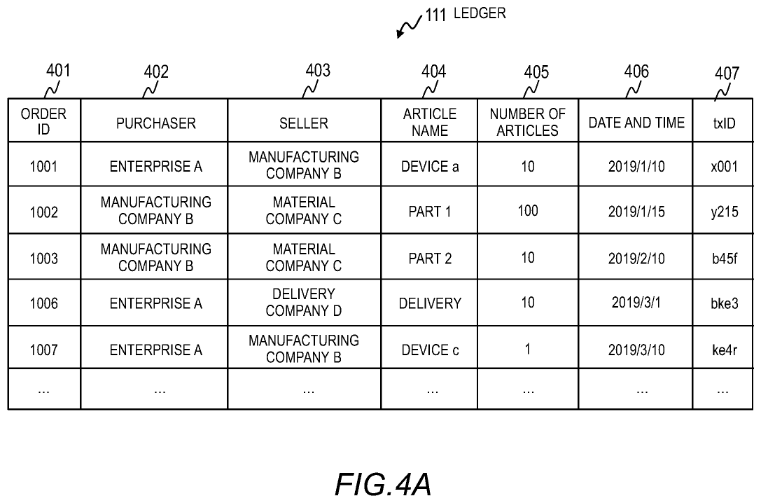

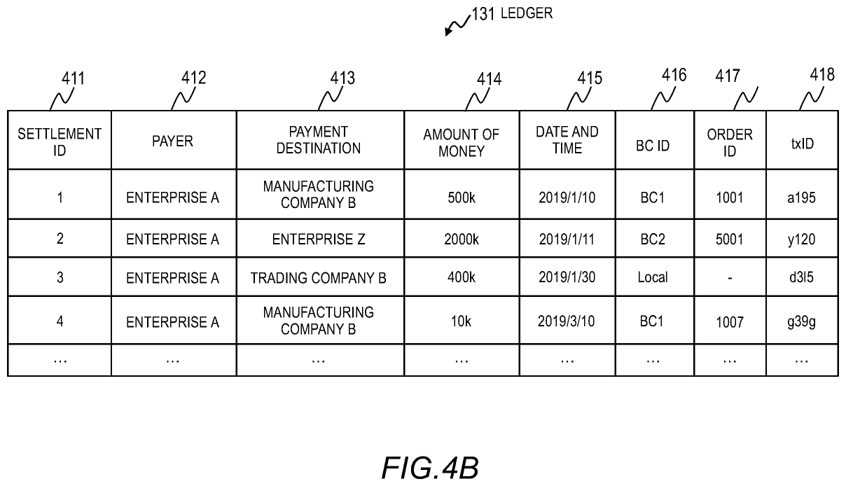

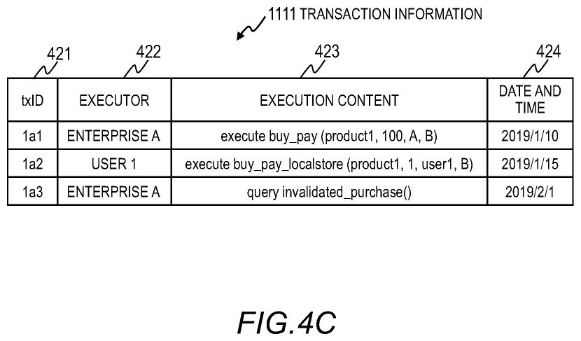

An example of the information of the ledger 111 is shown in FIG. 4A. FIG. 4A is a table of recorded information on transactions for purchase and sale of articles, but the recorded information is not limited to this example, and the ledger 111 can also record information other than the purchase and sale of the articles.

The ledger 111 includes seven data items of an item 401 to an item 407 in one entry. The item 401 indicates order ID information for identifying data recorded in the ledger 111. The item 402 indicates information on a purchaser in a transaction recorded in the ledger 111. The item 403 indicates information on a seller in the transaction. The item 404 indicates information on an article name purchased in the transaction.

The item 405 indicates the number of the articles. The item 406 indicates information on a date and time of execution of the transaction. The item 407 indicates a transaction ID (txlD) for identifying the transaction.

Moreover, as shown in FIG. 4C, as the information of the ledger 111, transaction information 1111 relating to transactions for actually executing update of and reference to the ledger 111 may be recorded. The transaction information 1111 of FIG. 4C can be used to add an entry having a transaction ID (item 421) matching the transaction ID (item 407) of FIG. 4A to the ledger 111. Tampering resistance of the transaction data can be increased by obtaining hash values of those pieces of transaction data, and recording the hash values chained with hash values of past transaction data.

The transaction information 1111 includes, for example, four data items of an item 421 to an item 424 in one entry. The item 421 indicates the transaction ID for identifying a transaction, and is the transaction ID of the item 407 of FIG. 4A.

The item 422 indicates an execution subject of the transaction. The item 423 indicates an execution content of the transaction, and stores a program name, arguments, and the like. The item 424 indicates a date and time of the execution of the transaction.

When the consensus building module 107 receives, for example, an update request for the ledger 111, the consensus building module 107 verifies the update request in advance before the update is executed, determines whether or not the ledger 111 is to be updated in consideration of prior verification results of other computers 101 within the own blockchain BC #1, and executes the update in accordance with a determination result.

Description is now given of information (concealment control information 130) other than the programs stored in the memory 122 of the computer 121.

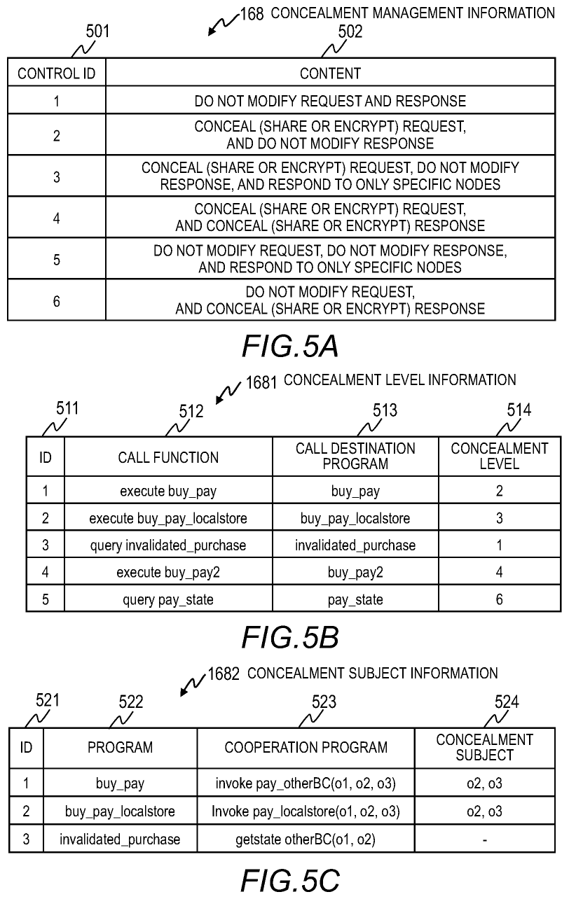

The concealment control information 130 is information for determining, when a cooperation request is received from the computer 101 belonging to the another blockchain BC #1, a concealment level of the cooperation request. In the at least one embodiment, this concealment control information 130 is obtained by sharing, in advance, with the computer 121, a content of the concealment management information 168 (shown in FIG. 5A described below) on concealment control generated by the server 161, and is then used.

As shown in FIG. 5A, the concealment management information 168 on the concealment control includes two data items of an item 501 and an item 502 in one entry. The item 501 indicates a control ID for identifying a content of the concealment control.

The item 502 indicates the concealment control content, such as a content of a concealment request received from the computer 101, a concealment method applied to or to be applied to a content of a response, and the like.

Meanwhile, in a modification example of the at least one embodiment, the concealment control information 130 may independently be defined on the computer 121 side to be used in addition to the concealment management information 168 described above. As a result, for example, even when a concealment request for a response content does not exist in a cooperation request from the computer 101 side, when the response is to be concealed for the sake of the blockchain BC #2 side to which the computer 121 belongs, the response can be concealed and then returned.

As a result, a mistake of concealment setting of the cooperation source side or the like can be addressed, and stricter access control for the data can be achieved.

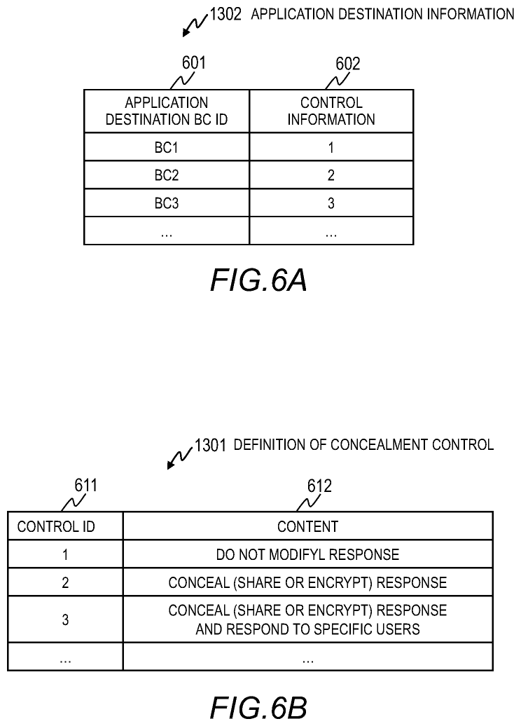

In the modification example of the at least one embodiment, the concealment control information 130 held by the computer 121 of the blockchain BC #2 is formed of a concealment control definition 1301 of FIG. 6B and application destination information 1302 relating to an application destination of the concealment control of FIG. 6A in addition to the content of the concealment management information 168 described above.

The concealment control definition 1301 of FIG. 6B includes two data items of an item 611 and an item 612 in one entry. The item 611 indicates a control ID for identifying a content of the concealment control. The item 612 indicates the control content of the concealment to be applied to a response content to the computers 101 or the like.

When a cooperation request received from the computer 101 includes a concealment request for a content to be returned as a response by the computer 121, concealment control set by the computer 121 of the cooperation destination and to be applied to the response is basically prioritized. It should be noted, however, that, in order to consider higher safety, for example, when the concealment request received from the computer 101 requires higher confidentiality than that of the concealment request for the response set by the computer 121 of the cooperation destination, the concealment request for the response requested by the computer 101 side may be prioritized.

The application destination information 1302 of FIG. 6A relating to an application destination of the concealment control includes two data items of an item 601 and an item 602 in one entry. The item 601 indicates a BC ID as an identifier for identifying a blockchain of the application destination. The BC ID is defined for each blockchain by, for example, the server 151 of the BC authentication organization. Computers belonging to the same blockchain belong to a blockchain having the same value of the BC ID. The item 602 indicates a value corresponding to the control ID (concealment level) of the item 611 of FIG. 6B, and specifies a content of the concealment control to be applied. For example, when the value of the item 601 is “BC1,” concealment control having “1” in the control information (602) corresponding to the control ID 611, specifically, processing of responding without any concealment of a response to the computer 101, is applied to the computers 101 belonging to the blockchain BC #1 having a BC ID of “BC1.”

Meanwhile, when the value of the item 601 is “BC3,” concealment control defined in an entry having “3” as a value (concealment level) of the control ID 611, specifically, processing of sharing or encrypting a response content as a response to the computer 101, is applied to a computer belonging to a blockchain having “BC3” as a BC ID. Well-known or a publicly-known technologies are only required to be applied to the sharing (secret sharing) and the encryption, and a detailed description is not thus given in the at least one embodiment.

Description is now given of the program information stored in the memory 122 of the computer 121 of the blockchain BC #2.

The cooperation module 125 communicates data to/from the computers belonging to the own blockchain BC #2, the computers 101 belonging to the another blockchain BC #1, the client terminals 141, the servers 161, and the like.

The transaction management module 126 executes and manages a transaction for a cooperation request received from the computer 101 belonging to the blockchain BC #1 or the like, such as executing writing or reference to the ledger 131 or causing a requested transaction to wait.

An example of the information of the ledger 131 is shown in FIG. 4B. FIG. 4B is an example of the ledger 131 for recording transactions relating to the payments of articles. However, the information is not limited to this example, and the ledger 131 may record information other than the payments. As in the case of the ledger 111, tampering resistance of the transaction data can be increased by obtaining hash values of those pieces of transaction data, and recording the hash values chained with hash values of past transaction data.

The ledger 131 includes eight data items of an item 411 to an item 418 in one entry. The item 411 indicates settlement ID information for identifying data recorded in the ledger 131. The item 412 indicates information on a payer in a recorded transaction.

The item 413 indicates a payment destination in the transaction. The item 414 indicates an amount of money paid in the transaction. The item 415 indicates a date and time of the made payment. The item 416 indicates ID information for identifying, for the recorded transaction, a blockchain to which a computer which has made a request belongs to. For example, an entry in which the value of the settlement ID is “1” has “BC1” as the value of the BC ID, indicates a transaction which is invoked due to a transaction of an article purchase which occurs in a cooperation source blockchain having “BC1” as the value of the BC ID, and is fora payment request in a cooperation destination blockchain. An entry in which the value of the settlement ID is “3” has “Local” as the value of the BC ID, and indicates that the transaction is not a transaction of payment generated due to cooperation, but is a transaction executed in response to reception of a transaction execution request for direct payment from the server 161 or the like to a blockchain for this payment.

The item 417 indicates an order ID for enabling identification of an order of the blockchain BC #1 of the cooperation source with which this settlement is associated. The order ID of the item 417 corresponds to the order ID 401 of the ledger 111 managed by the blockchain BC #1 of the cooperation source.

The item 418 is ID information for identifying a transaction recorded in the blockchain BC #1 of the cooperation destination. For the ledgers of FIG. 4A and FIG. 4B, various implementation methods are conceived. For example, in a case of the ledger of FIG. 4A, it is assumed that respective organization described as the purchaser and the seller hold the ledgers 111 having the same content and all of the organizations can view the entire content of the ledgers. In a case of the ledger of FIG. 4B, it is assumed that the ledgers 131 having contents different among organizations described as the payers are held, and the contents of the ledgers are shared among only parties directly concerned with transaction. For example, the content of FIG. 4B is a ledger held by an organization “enterprise A” as a payer, and, as the content of the ledger, contents of transactions having settlement IDs “1” and “4” are shared with only a manufacturing company B. That is, the contents of those transactions are recorded also in a ledger on the manufacturing company B side, and the manufacturing company B can refer to the recorded content. Similarly, a content of a transaction having “2” as the settlement ID is shared with only an enterprise Z, and the other organizations cannot refer to the content. As an implementation method for the ledger 131 of the cooperation destination blockchain, the method of FIG. 4B in which a content of a ledger is shared among only parties directly concerned with transaction is assumed, but the method of FIG. 4A in which a content of a ledger is shared among all of the organizations may be used. This configuration is described below as Modification Example 2.

When the consensus building module 127 receives, for example, an update request for the ledger 131, the consensus building module 127 verifies the request in advance before the execution of the update, determines whether the ledger 131 is to be updated or not in consideration of prior verification results of other computers 121 within the own blockchain BC #2, and executes the update in accordance with a determination result.

For the consensus building, the computers 121a to 121c which build the consensus may be set in advance. Moreover, it is only required to apply a well-known method or a publicly-known method to a procedure of the consensus building and the like, and a detailed description is not given in the at least one embodiment.

When the data concealment module 128 receives a cooperation request from the computer 101 or the like, the data concealment module 128 executes predetermined concealment processing, such as the sharing or the encryption of a response content, in accordance with the concealment level of the cooperation request, the concealment level for a response set on the computer 121 side, or the like.

The concealment restoration module 129 executes, for a cooperation request received from the computer 101 or the like, restoration of a request content in accordance with the concealment level or the like.

The information stored in the memory 162 of the server 161 is now described. The cooperation module 165 cooperates with external computers, such as the computer 101 belonging to the blockchain BC #1 of the cooperation source, the computer 121 of the blockchain BC #2 of the cooperation destination, and the client terminal 141, to thereby transmit an execution request for a transaction and the like to the computer 101 and the like. Moreover, the cooperation module 165 executes reception of a response result from an external computer and the like.

When the data concealment module 166 receives a cooperation request from the client terminal 141 or the like, the data concealment module 166 executes predetermined concealment processing, such as the sharing or the encryption of the content, in accordance with the concealment level of the cooperation request.

The concealment restoration module 167 executes, for a processing result of a cooperation request received from the computer 101 or the like, restoration of data and the like in accordance with the concealment level and a content of the processing result.

The concealment management information 168 is formed of, as given in the description of the concealment control information 130 described above, the information on the concealment control which is shown in FIG. 5A, concealment level information 1681 indicating a concealment level in each call function which is shown in FIG. 5B, and concealment subject information 1682 indicating a concealment subject in a second processing request invoked based on the call function which is shown in FIG. 5C.

The concealment management information 168 relating to the concealment control is, as described above, information which defines the level (control ID) and the content of the concealment to be applied to a request which relates to the cooperation, and is transmitted to the computer 101 and a response content, and the concealment management information 168 can be shared in advance with the computer 121 and the like, and can then be used.

The concealment level information 1681 of FIG. 5B is information indicating the level of the concealment in each call function as described above, and a concealment level (514) of a call function accompanied by a cooperation request is defined by this information. The concealment level information 1681 includes four data items of an item 511 to an item 514 in one entry.

The item 511 is ID information for identifying each call function for which the concealment level is defined. The item 512 indicates a call function corresponding to the ID information, and indicates a function to be used when the server 161 transmits a processing request to the computers 101. The item 513 indicates information on a program to be executed in each computer 101 of the blockchain BC #1 of the cooperation source when this call function is called.

The Item 514 indicates the level of concealment to be applied to cooperation processing invoked in the blockchain BC #1 when this call function is called. The item 514 indicates the control ID of the item 501 of the concealment management information 168, and controls presence/absence of the concealment and the like thorough reference to the concealment management information 168.

FIG. 5C shows the concealment subject information 1682 indicating concealment subjects in a cooperation request as described above. The concealment subject information 1682 includes four data items of an item 521 to an item 524 in one entry.

The item 521 is ID information for identifying each program being a source of a cooperation request. The item 522 indicates the program being the source of the cooperation request, and corresponds to the call destination program of the item 513 of FIG. 5B. The item 523 indicates a program to be invoked at the cooperation destination, and indicates a program (cooperation program) invoked in cooperation with the computer 121 of the blockchain BC #2 when the program of the item 522 is invoked in the computer 101.

The item 524 indicates concealment subjects of the program (523) invoked in response to the cooperation request. For example, the item 524 indicates that a program having “1” as the value of the item 521 is the program (523) invoked in response to the cooperation request, and uses “o1, o2, and o3” as arguments, and only “o2 and o3” of the arguments are concealed by the computer 121 through use of the encryption, the secret sharing, or the like.

The information stored in the memory 142 of the client terminal 141 is now described. The cooperation module 145 cooperates with external computers such as the server 161 to transmit a processing request which is a source of a transaction request directed to the computers 101 or the like, and includes requests for order reception, order placement, and a payment. Moreover, the cooperation module 145 executes reception of a response result from an external computer and the like.

The hardware configuration and the software configuration of the computer system according to the at least one embodiment have been described above.

Description is now given of an example of the cooperation processing in the at least one embodiment based on the above-mentioned hardware configuration and software configuration. In the cooperation processing in the at least one embodiment, the client terminal 141 first transmits a processing request indicating purchase of an article and payment processing to the server 161. The processing request includes a call function (item 512) of FIG. 5B.

The server 161 executes the call function (item 512), and a call destination program (item 512 and item 522) corresponding to the call function is invoked in the computers 101. After that, each computer 101 requests the computers 121 of the blockchain BC #2 to execute a cooperation program (item 523) corresponding to the program (item 522) of FIG. 5C.

Each computer 101 of the blockchain BC #1 executes a transaction of the purchase of the article corresponding to the call destination program (item 513).

Moreover, when a cooperation request is included in the processing request, a cooperation program (item 523) corresponding to the program (item 522) executed by the computer 101 is executed by the computers 121, and the transaction relating to the payment is executed.

The server 161 applies the concealment processing to the request of or a response to the transaction of the payment processing in accordance with the cooperation program to be executed, to thereby avoid acquisition of unnecessary information by the computers 101 of the blockchain BC #1.

The blockchain BC #1 executes the purchase processing (processing request) for the article requested by the server 161, and updates the ledger 111. Moreover, the blockchain BC #2 updates the ledger 131 through use of the cooperation program (item 523) executed by each computer 121.

When the transaction of the payment processing includes a concealed portion, each computer 121 of the blockchain BC #2 restores the concealed portion, executes predetermined processing, and updates the ledger 131. After that, when a request for concealment of a response to the transaction for the payment processing is included, the computer 121 conceals the response to the payment processing (cooperation request), and return the response to the computers 101 of the blockchain BC #1 as a response.

When each computer 101 of the blockchain BC #1 receives the responses to the transaction for the payment processing from the blockchain BC #2, the computer 101 returns a response to the transaction for the purchase processing and the responses to the transaction for the payment processing to the server 161 as a response.

When the transaction for the payment processing has a concealed portion, the server 161 restores the concealed portion, transmits, to the client terminal 141, a result of the transaction for the purchase of the article and the result of the transaction for the payment, and completes the series of steps of cooperation processing.

<Determination of Whether or not Concealment is Required and Concealment Processing at Cooperation Destination>

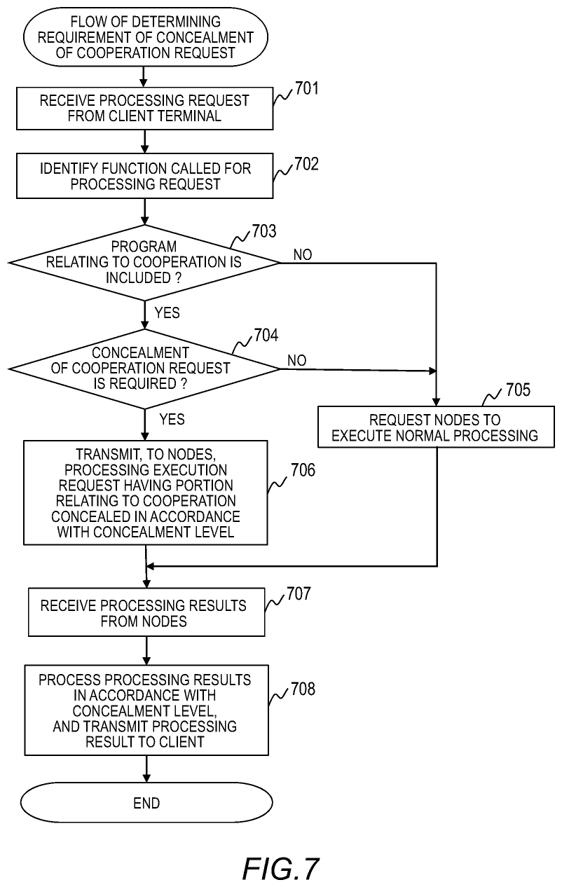

FIG. 7 is a flowchart for illustrating an example of determination of whether or not the concealment is required for a processing request relating to the blockchain BC #2 of the cooperation destination and concealment processing which is executed by the server 161 in the at least one embodiment of this invention.

This processing is executed when the server 161 receives a processing request from the client terminal 141 or when a predetermined timing is reached in the server 161. A detailed description is now given of the processing.

The cooperation module 165 of the server 161 receives, from the client terminal 141, a processing request, such as a purchase of an article or a payment (Step 701). The cooperation module 165 identifies a call function (item 512) to be used when a processing request is transmitted to the computers 101 based on the processing request (Step 702).

For example, the cooperation module 165 outputs, to the client terminal 141, a setting screen for setting the processing request, and the call function which makes a processing execution request to the computers 101 is determined in response to processing selected on the setting screen by a user of the client terminal 141. In Step 703, the cooperation module 165 determines whether the identified call function is to invoke processing relating to the cooperation of the blockchain. Of the call functions, the call functions which are relevant to the cooperation of the blockchain are managed as the concealment level information 1681 of FIG. 5B. When the call function to be used exists in the item 512, the cooperation module 165 determines that the call function to be used invokes processing relating to the cooperation. Not only the program relating to the cooperation, but also a program which is not relevant to the cooperation may together be invoked in the computers 101.

In the determination of Step 703, when the cooperation module 165 determines that the processing request received from the client terminal 141 does not relate to a program relevant to the cooperation of the blockchain, the processing request includes only processing to be applied to the blockchain BC #1, and the process proceeds to Step 705.

In Step 705, the cooperation module 165 determines that the processing request does not include the cooperation with another blockchain, and includes only processing closed within the local blockchain BC #1, does not conceal the processing request directed to the computers 101 (in FIG. 7, “nodes”), and simply makes a processing request such as update of the ledger 111 of the computer 101.

Meanwhile, when the cooperation module 165 determines that there exists a program relating to the cooperation of the blockchain in the determination of Step 703, the process proceeds to Step 704, and the cooperation module 165 determines whether or not the concealment of data on a cooperation content is required.

Specifically, the cooperation module 165 refers to the concealment level information 1681, and identifies the concealment level in the item 514 corresponding to the item 513 of a call destination program to be invoked by the calling program. After that, the cooperation module 165 refers to the concealment management information 168 to identify the content of the item 502 of an entry having a control ID 501 corresponding to the concealment level, to thereby determine whether or not the concealment of the cooperation request is required (Step 704).

In Step 706, when the cooperation module 165 determines that the content of the cooperation from the blockchain BC #1 to the blockchain BC #2 is required to be concealed, the cooperation module 165 conceals the cooperation request in accordance with the content of the concealment of the item 502 of the concealment management information 168, and transmits the concealed processing execution request to the computers 101.

When the control ID of the item 501 is “4” or “6,” the information (concealment request) indicating that a content of a response to the cooperation request is required to be concealed may be added to this cooperation request, and, otherwise, information indicating that the content of the response is not required to be concealed may be added to this cooperation request.

For example, when the concealment level of the item 514 of FIG. 5B is “2,” the cooperation request is to be concealed, and the computers 121 of the blockchain BC #2 of the cooperation destination are requested not to conceal the response content. As the concealment method, for example, there are conceived a method of using a public key of the computer 121 of the cooperation destination for the concealment and a method of using the secret sharing or the like to divide the cooperation content into a plurality of pieces of data called shares so that the original data cannot be restored unless a certain number of shares or more are obtained.

Depending on the type of the blockchain BC #1 to which the computers 101 belong, there is a case in which the same processing request is required to be made to all of the computers 101 which are relevant to the consensus building within the blockchain BC #1.

In this case, when the same processing execution request is sent to a plurality of computers 101 of the blockchain BC #1 of the cooperation source, a plurality of the same cooperation requests are also sent to the computers 121 of the blockchain BC #2 of the cooperation destination. Moreover, when information on settlement or the like is included as the cooperation content of the processing execution request, this information is delivered not only to parties concerned in the blockchain BC #2, but also to all of the computers 101 participating in the blockchain BC #1.

Thus, when cooperation is to be established between the blockchains BC #1 and BC #2, a processing execution request is transmitted to all computers (nodes) relevant to the consensus building, but a portion of the processing execution request relating to a content of the cooperation (cooperation request) is concealed through the encryption, the secret sharing, or the like, and the portion is transmitted.

For example, when a function of “execute buy_pay” in the item 512 of the concealment level information 1681 is called, and “a, b, c, d, o1, o2, and o3” are specified as arguments thereof, “invoke pay_otherBC(o1,o2,o3)” is called as the corresponding cooperation program based on the item 513 (call destination program) of the concealment information 1681 and the item 522 and the item 523 of the concealment subject information 1682.

Of those arguments, arguments relevant to the cooperation are “o1, o2, and o3,” and the data concealment module 166 conceals only the arguments of “o2 and o3” through the encryption, the secret sharing, or the like based on the specification of the concealment subjects of the item 524. After that, the data concealment module 166 transmits the concealed arguments when the first processing execution request for “execute buy_pay” is made. When a processing execution request is transmitted to the plurality of computers 101 belonging to the blockchain BC #1 of the cooperation source, and the secret sharing is used as the concealment method, the secret sharing is applied to a portion of a processing request relating to the cooperation, and pieces of data different among the computers 101 are transmitted.

A plurality of cooperation requests are transmitted from those computers 101 to the computers 121 belonging to the blockchain BC #2 of the cooperation destination. The computer 121 side which has received the cooperation requests restores the plurality of distributed cooperation requests as a set, to thereby consider the cooperation requests as one cooperation request, and the processing is consequently executed not a plurality of times, but only once.

On the computer 121 side which receives the cooperation requests, in order to be able to distinguish the secret sharing based on the same original data, for example, identification data such as the same sharing ID may be included in the cooperation requests for the identification.

Meanwhile, encryption other than the secret sharing is to be executed as the concealment method, the processing execution request which has the portion relating to the cooperation and has been encrypted in the same manner is transmitted to each computer 121.

Each computer 101 includes the sharing ID and the information on the concealment level in the encrypted cooperation request, and transmits the cooperation request to the computers 121 of the blockchain BC #2 of the cooperation destination. With this configuration, each computer 121 of the blockchain BC #2 of the cooperation destination may be caused to determine that the same processing request is encrypted, and only one processing request may be restored, and then may be processed.

As another example, the server 161 may transmit, as the first processing execution request, a processing execution request including an encrypted cooperation processing content to only one of the computers 101 belonging to the blockchain BC #1 of the cooperation source, and may transmit a processing execution request not including the encrypted cooperation processing content to other computers 101.

With this configuration, the processing request relating to the own blockchain BC #1 is transmitted to all of the computers 101 of the blockchain BC #1 of the cooperation source, but the processing request relating to the cooperation is transmitted only one of the computers 101, and only one cooperation request is transmitted to the computers 121 of the blockchain BC #2 of the cooperation destination. When a content of the cooperation can be disclosed to the one computer 101 which receives the processing request relating to the cooperation, a processing request which is not encrypted may be transmitted, or the processing request may be transmitted to any number of computers 101 in addition to the one computer 101 as the transmission destinations of the processing request relating to the cooperation.

Arguments used for the reference to and the update of the blockchain BC #1 of the cooperation source are only “a, b, c, and d” of the above-mentioned arguments. Thus, even when each computer 101 belonging to the blockchain BC #1 of the cooperation source receives arguments different from those of the other computers 101 in a first processing request, the computer 101 inputs only arguments (only “a, b, c, and d”) relevant to the own blockchain BC #1 as the transaction request directed to the own blockchain BC #1, and executes the transaction processing.

As a result, each computer 101 executes the same transaction processing, and the consensus building processing can be advanced. The determination of which arguments are relevant to the blockchain BC #1 of the own computer 101 can be made based on the internal arguments set to the item 206 of the program management information 108.

When the concealment level is “2,” the same content without concealment is returned to each computer 101 of the cooperation source as a response from the computers 121 of the cooperation destination. Meanwhile, when the concealment level is “3,” for example, a result is returned to only specific nodes of the computers 101 of the blockchain BC #1 of the cooperation source, for example, only nodes of an executor and a target of the settlement when the cooperation request is settlement. The computers 121 of the cooperation destination side can determine which nodes are the executor and the target of the settlement by including information on the nodes in the processing request for the settlement.

Each specific node which has received processing results of the cooperation request from the computers 121 cannot record the response results in the ledger 111 of the own blockchain BC #1. Thus, for example, the processing results may be recorded off-chain in a local database or the like other than the blockchain BC #1.

Moreover, when the concealment level is “4,” in addition to the concealment of the request for the cooperation, the response content concealed by each computer 121 of the cooperation destination is returned to the computers 101 of the cooperation source.

This configuration intends such a case that the response content is disclosed to none of the computers 101 of the blockchain BC #1 of the cooperation source, and a response result is not intended to be disclosed to parties other than the client terminal 141 which has first transmitted the original request to the server 161. The concealed response contents are restored by the server 161, and are presented to the client terminal 141. When the secret sharing is used as the concealment method, the server 161 collects distributed response results received from the respective computers 101 of the blockchain BC #1 of the cooperation source, to thereby restore data.

Moreover, when encryption other than the secret sharing is used as the concealment method, for example, data is encrypted through use of a public key of the server 161, and the data is restored through use of a private key corresponding to the public key.

The processing request for the cooperation in Step 706 has been described above. After the processing steps of Step 705 and Step 706, the server 161 receives the processing results from the computers 101 of the blockchain BC #1 of the cooperation source (Step 707).

The server 161 processes the processing results in accordance with the concealment level of the processing requests transmitted first, and notifies the client terminal 141 of the processing result (Step 708). For example, when the concealment level is “4,” the concealment restoration module 167 of the server 161 restores the concealed data, and notifies the client terminal 141 of the data.

When the response content from the blockchain BC #2 is not concealed, the server 161 does not process the data as descried above, and notifies the client terminal 141 of the data as it is. Description has been given above of the determination of whether or not the concealment of the cooperation destination is required and the concealment processing in the at least one embodiment.

<Processing of Computers of Blockchain of Cooperation Source>

Description is now given of the cooperation processing executed by the computers 101 of the blockchain BC #1 of the cooperation source in the at least one embodiment.

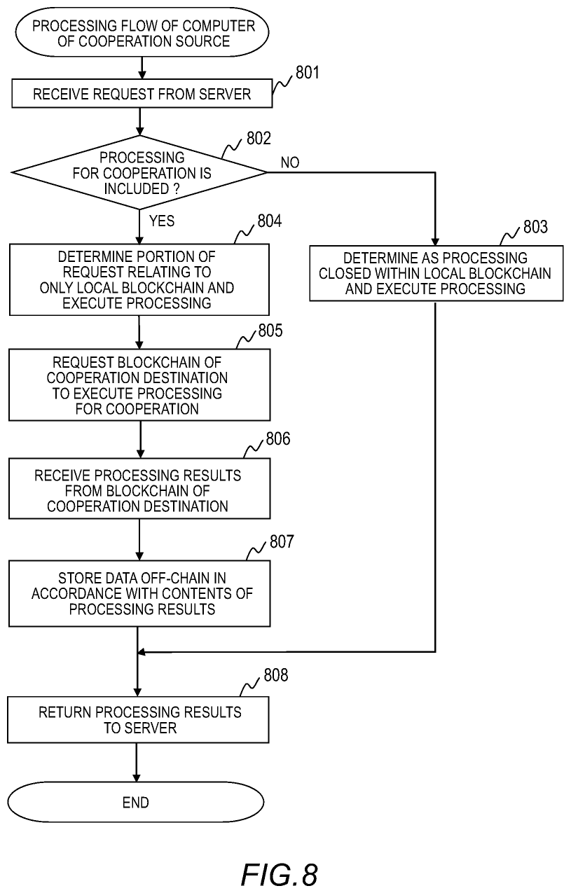

FIG. 8 is a flowchart for illustrating an example of processing executed by the computers 101 for the cooperation with the computers 121 in the at least one embodiment of this invention.

The cooperation module 105 of the computer 101 receives a processing execution request from the server 161 (Step 801). The cooperation module 105 determines whether or not the processing execution request includes a cooperation request for cooperation with the blockchain BC #2, determines that the processing is closed within the own blockchain BC #1 when a cooperation request is not included, and executes requested processing, such as reference to or update of the ledger 111, as usual (Step 803).

Meanwhile, when a cooperation request for the cooperation with the blockchain BC #2 is included, the computer 101 extracts, from the processing execution request, only a processing request relevant to the own blockchain BC #1, and executes requested processing, such as reference to or update of the ledger 111 of the own blockchain BC #1 (Step 804).

The determination of the portion relevant to the own blockchain BC #1 of the processing request can be executed by, for example, referring to the internal arguments of the item 206 and the external arguments of the item 207 of the program management information 108. For example, when the computer 101 receives, as the arguments for the processing request, “a, b, c, d, o1, o2, and o3” from the server 161, and the program having the value “5” in the item 201 is invoked as requested by the processing execution request, the cooperation module 105 inputs only the arguments “a, b, c, and d” as the portion relevant to the own blockchain BC #1, and the transaction management module 106 executes transaction processing for the blockchain BC #1.

After that, the cooperation module 105 causes the computers 121 of the cooperation destination to process the cooperation request (Step 805). For example, in the above-mentioned example, the cooperation module 105 uses “o1, o2, and o3” of the arguments of the processing execution request to make the cooperation request to the computers 121. For example, when the cooperation request is a request for settlement, a source and a destination of the settlement, a method of the settlement, information on an amount of money, and the like may be specified.

Each computer 101 receives processing results of the cooperation request from the computers 121 of the cooperation destination (Step 806). The computer 101 off-chain stores the processing results in accordance with the contents of the received processing results of the cooperation (Step 807). For example, when a function such as a call destination program “buy_pay_localstore” in the item 513 is called in response to a request from the server 161, the cooperation module 105 stores the response results in a local database (not shown).

When a function as described above is not called, the computers 101 may not particularly store the response results of the cooperation request. After the processing steps of Step 803 and Step 807, each computer 101 transmits a processing result for the processing request and the processing results for the cooperation request to the server 161 (Step 808). Description has been given above of the cooperation request processing executed by the computers 101 belonging to the blockchain BC #1 of the cooperation source in the at least one embodiment.

<Processing of Computers of Cooperation Destination Having Received Cooperation Request>

Description is now given of processing executed in the computers 121 of the cooperation destination which have received a cooperation request in the at least one embodiment.

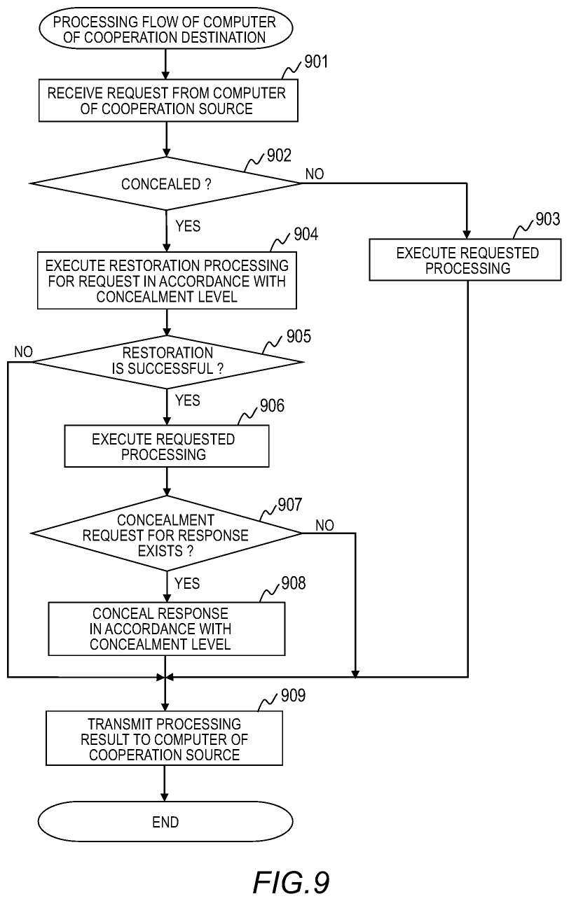

FIG. 9 is a flowchart for illustrating an example of processing executed by the computer 121 for the cooperation request in the at least one embodiment of this invention.

The cooperation module 125 of the computer 121 receives the cooperation request from the computers 101 (Step 901). The cooperation module 125 determines whether or not the cooperation request has been concealed (Step 902). The determination of whether or not the cooperation request has been concealed may be made by, for example, adding identification information indicating presence/absence of the concealment, such as the encryption or the secret sharing, when the second processing requests are transmitted from the computers 101 to the computers 121, and making the determination by each computer 121 based on the identification information.

As another example, the server 161 may add the concealment level of the item 514 of the concealment level information 1681 to the cooperation request, and the computer 121 may determine whether or not the cooperation request has been concealed based on the value of the concealment level.

When the cooperation request has not been concealed, the computer 121 executes the reference processing or the update processing for the ledger 131 of the own blockchain BC #2 based on the requested information as usual (Step 903).

When the cooperation request has been concealed, the concealment restoration module 167 of the computer 121 restores (decrypts) the data on the cooperation request in accordance with the notified concealment level (Step 904).

For example, when the secret sharing is applied, the concealment restoration module 167 collects pieces of data having the same sharing ID information in the cooperation requests (the pieces of sharing data have the same original data), restores the content of the cooperation request based on the pieces of data, and executes processing. Meanwhile, when the encryption is applied by a public key cryptography or the like, the concealment restoration module 167 uses an own private key to decrypt the data.

When encryption other than the secret sharing is applied, an encrypted cooperation request may be transmitted from only a single computer as described above, but, for example, identification ID information indicating the same processing request may be included in a message for the cooperation request, the encrypted cooperation request may be transmitted from a plurality of computers, the public key code may be decrypted on the computer 121 side, and only one of the cooperation requests having the same ID may be executed.

When the computer 121 fails in the decryption of the cooperation request, the computer 121 may transmit a result of the failed processing to the computers 101 of the cooperation source (Step 909). When the computer 121 succeeds in the decryption of the cooperation request, the computer 121 executes the decrypted processing in the transaction management module 126 (Step 906).

For example, when the computer 121 receives a cooperation request relating to the settlement, the computer 121 executes writing of settlement information for identifying a payment source and a payment destination to the ledger 131, acquisition of information from the ledger 131, and the like. When the computer 121 returns the processing result to the computers 101 of the blockchain BC #1 as a response, the computer 121 determines whether or not the concealment of the response is required based on the information on the concealment level defined in the cooperation request (Step 907).

When the concealment of the response is not required, the computer 121 transmits, without concealment, the processing result for the cooperation request to the computers 101 (Step 909). When the concealment of the response content is required, the data concealment module 128 of the computer 121 conceals the response content in accordance with the concealment level (Step 908).

For example, when the concealment level is “3,” the data concealment module 128 returns the response result to only specific nodes. For narrowing down to the specific nodes, for example, when a settlement request (cooperation request) is received as described above, parties concerned are identified based on information on a subject and an object of execution of the settlement included in the settlement request, and detailed response information is returned to only the computers 101 of the blockchain BC #1 of the cooperation source corresponding to the identified parties.

Moreover, when the concealment level is “6,” the data concealment module 128 conceals the response content through use of the secret sharing, the public key cryptography, or the like, and transmits the response content to the computers 101.

As described above, the computer 121 executes a cooperation program (item 523) specified in the cooperation request, and transmits a processing result to the computers 101 (Step 909). Description has been given above of the processing executed by the computers of the cooperation destination which have received the cooperation request in the at least one embodiment.

<Modification Example of Processing of Computers of Cooperation Destination Having Received Cooperation Request>

Description is now be given of the modification example of the at least one embodiment of this invention. In the above-mentioned at least one embodiment, when the cooperation request transmitted from the computer 101 does not include the concealment request for the response, the computer 121 transmits a response content without concealment.

In this modification example, by independently defining a concealment level relating to the response on the computer 121 side of the cooperation destination, even when the cooperation request transmitted from the cooperation source does not include the concealment request for the response, the response content can be concealed and returned.

As a result, this modification example has, for example, an object to prevent a case in which the cooperation source is required to request the concealment of the response, but the response content which is to be concealed is leaked due to setting error by mistake or the like. In this modification example, as described above, the computer 121 side holds the application destination information 1302 of FIG. 6A and the concealment control definition 1301 of FIG. 6B as the concealment level for the response defined independently.

In this modification example, the processing of the computers 121 of FIG. 9 is different from that in the at least one embodiment, and the different portion (a portion after Step 903 and a portion after Step 907) is described.

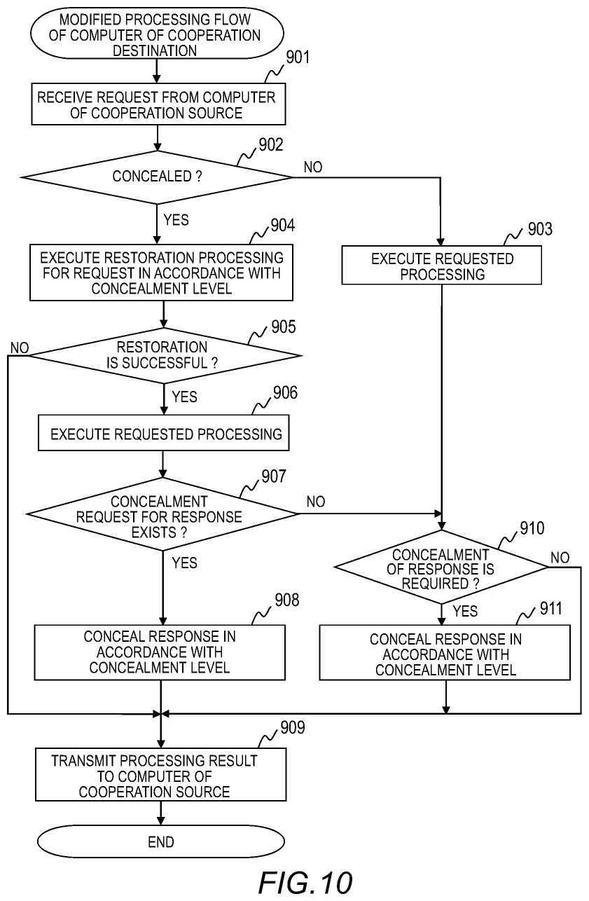

FIG. 10 is a flowchart for illustrating processing executed by the computer 121 for the cooperation request received from the computers 101 in the modification example of the at least one embodiment of this invention.

Step 901 and Step 902 are the same as those of FIG. 9 in the at least one embodiment, and when the cooperation request has not been concealed, the process proceeds to Step 903, and the cooperation module 125 of the computer 121 executes the requested processing.

When the cooperation module 125 of the computer 121 is to return the processing result corresponding to the cooperation request to the computers 101 as a response, the cooperation module 125 determines whether or not the concealment of the response content is required based on the application destination information 1302 on the concealment level defined independently (Step 910).

When the concealment is not required, the process proceeds to Step 909, and the cooperation module 125 returns the processing result without concealment to the computers 101. Meanwhile, when it is determined that the concealment is required, the cooperation module 125 of the computer 121 conceals the response content based on the application destination information 1302 and the concealment control definition 1301 (Step 911).

For example, in the case of the application destination information 1302 of FIG. 6A, when the BC ID being the identification information of the blockchain BC #2 to which the computer 121 responding to the cooperation request belongs is “BC2,” the concealment level is “2,” and hence the response content is concealed based on the concealment control definition 1301 of FIG. 6B, and is then returned.

In the description given above, granularity of the setting of the concealment level is the BC of the response source as a unit, but the concealment level may be set for a program specified by the cooperation request as a unit. The computer 121 transmits, to the computers 101, the response result to which the above-mentioned processing is applied.

Moreover, when the cooperation request is concealed, but the concealment request for the response is not included in the cooperation request in Step 907, the cooperation module 125 of the computer 121 determines whether or not the concealment of the response content is required as in Step 910 and Step 911 described above, and transmits the processing result to the computers 101 with or without the concealment of the response. The modification example of the at least one embodiment of this invention has been described above.

<Modification Example 2 of Processing of Computers of Cooperation Destination Having Received Cooperation Request>

Description is now be given of Modification Example 2 of the at least one embodiment of this invention. In the above-mentioned at least one embodiment, as the ledger 131 of the blockchain of the cooperation destination, it is assumed that each content of the ledger is shared among only the parties directly concerned with transaction, but, in Modification Example 2, description is given of a processing method executed in a case in which each content of the ledger is also shared among parties which are parties other than the parties directly concerned with transaction, and participate in the blockchain of the cooperation destination.

In the case in which the contents of the ledger 131 of FIG. 4B are also shared among parties other than the parties directly concerned with transaction, for example, when a material company C also participates in the blockchain of the cooperation destination, the material company C can view both of the ledger 111 of the blockchain of the cooperation source and the ledger 131 of the blockchain of the cooperation destination. The material company C can collate the order IDs of the ledger 111 and the ledger 131 with each other to acquire even detailed purchase information on organizations not in a relationship of direct transaction. For example, the material company C can acquire even information on an amount of payment for a device “a” through collation of a value “1001” of the order ID. Thus, in Modification Example 2, information leading to supposition of the correspondence between the ledger 111 and the ledger 131 is encrypted, and is then described in the ledgers.

Specifically, in Step 906, when processing such as update of the ledger relating to a payment is requested, information, such as the date and time (item 415), the BC ID (item 416), and the order ID (item 417) of the ledger 131, is encrypted through use of a private key shared in advance between the parties concerned with transaction or a public key of a payment destination organization, and is then described in the ledger 131. With this processing, the contents of the ledger 131 are shared among parties other than the parties directly concerned with transaction of the blockchain of the cooperation destination, but the decryption of the contents can be limited to the parties directly concerned with transaction.

According to the at least one embodiment of this invention described above, for example, in the computer system including the client terminals 141, the computers 101 and 121, and the servers 161, each server 161 includes the concealment management information 168 for controlling whether or not the concealment is required for the cooperation request made to the computers 121 belonging to the blockchain BC #2.

The computer 101 belonging to the blockchain BC #1 holds the program management information 108 for distinguishing, for the program executed in the blockchain BC #1, the processing request relating to processing closed in the own blockchain BC #1 and the cooperation request relating to the cooperation, and the cooperation destination information 109 indicating the information on the computers 121 of the cooperation destination.

Moreover, the computer 121 belonging to the another blockchain BC #2 and receiving the request from the computers 101 belonging to the blockchain BC #1 holds the concealment control information 130 for determining whether or not the cooperation request received from the computers 101 belonging to the blockchain BC #1 is concealed and whether or not the concealment of the response content is required.

The server 161 determines the request content (processing execution request) to be transmitted to the computers 101 belonging to the blockchain BC #1 and the concealment level to be applied based on the instruction of the operation request, such as article purchase or settlement, from the client terminal 141, applies the encryption, such as the secret sharing or the public key cryptography, to the cooperation request included in the request in accordance with the concealment level, and transmits the processing execution request to each of the computers 101 belonging to the blockchain BC #1.

Each computer 101 which belongs to the blockchain BC #1, and has received the processing execution request discriminates a processing request which is included in the processing execution request, and is relevant to the own blockchain BC #1, and a cooperation request which is included in the processing execution request, and is relevant to the cooperation, inputs only the processing request which is included in the processing execution request, and is relevant to the own blockchain BC #1, and executes processing, such as the reference to and the update of the ledger 111 of the own blockchain BC #1.

After that, the computer 101 uses the cooperation request relevant to the cooperation to transmit the cooperation request to the computers 121 belonging to the another blockchain BC #2. Each computer 121 which belongs to the another blockchain BC #2, and has received the second processing request determines the presence or absence of the concealment of the cooperation request, restores, when the cooperation request has been concealed, the cooperation request through, for example, the collection of distributed request information for restoration or the decryption of the encrypted cooperation request, and executes the requested processing.

Moreover, when the computer 121 belonging to the another blockchain BC #2 returns the processing result to the computers 101 belonging to the blockchain BC #1 as a response, the computer 121 determines whether or not the concealment of the response content is required based on the concealment level set in the cooperation request or the concealment control information 130 defined by the computer 121 itself. Moreover, the computer 121 executes the encryption of the response content through the secret sharing or the public key cryptography and the narrowing-down of the transmission destinations of the processing result in accordance with the concealment level, and returns the processing result to the computers 101 belonging to the blockchain BC #1 as a response.

Each computer 101 belonging to the blockchain BC #1 stores the processing results in a local database in accordance with the concealment level, and returns the results of the requested processing to the server 161 as a response.

The server 161 collects the processing results received from a plurality of computers 101 belonging to the blockchain BC #1 to restore the processing result in accordance with the concealment level of the processing execution request transmitted first, and presents the restored result to the client terminal 141.

With the configurations described above, according to the at least one embodiment of this invention, when the blockchain BC #1 and the blockchain BC #2 are caused to cooperate with each other, data is shared in the blockchain BC #1 of the cooperation source, and the information which is not relevant to the blockchain BC #1 of the cooperation source, or which is not intended to be disclosed thereto, such as the information on the cooperation and the information managed by the another blockchain BC #2 for the cooperation, can be shared among only parties concerned.

The at least one embodiment of this invention is described above, but this invention is by no means limited to the at least one embodiment. It should be understood that this invention may be carried out in various modes without departing from the spirit of this invention.

### CONCLUSION

As described above, the computer system according to the at least one embodiment described above can be configured as follows.

(1) There is provided a server (161) including: a processor (CPU 163); a memory (162); an interface (164) coupled to a first computer (101); a cooperation module (165) configured to receive a processing request, determine whether the processing request includes a cooperation request indicating processing to be applied to a first blockchain (BC #1) to which the first computer (101) belongs and processing to be applied to a second blockchain (BC #2) to which a second computer (121) cooperating with the first computer (101) belongs, and to determine whether concealment of the cooperation request is required when the cooperation request is included; and a concealment module (data concealment module 166) configured to conceal the cooperation request required to be concealed based on a result of the determination, wherein the cooperation module (165) is configured to transmit, to the first computer (101), a processing execution request including the cooperation request which has been concealed by the concealment module in accordance with the result of the determination.

With the above-mentioned configuration, the data is shared among computers 101 (first computers) belonging to the blockchain BC #1 of the cooperation source (first blockchain), and the information which is not relevant to the participants of the blockchain BC #1 of the cooperation source, or which is not intended to be disclosed thereto, such as the information (cooperation request and response) managed by the blockchain BC #2 (second blockchain), can be shared among only parties concerned through the concealment of the cooperation request.

(2) The server according to Item (1) further includes concealment management information (168) in which a content of the concealment is set in advance, and the concealment module (166) is configured to determine a content of the concealment of the cooperation request based on the concealment management information (168).

With the above-mentioned configuration, the data concealment module 166 of the server 161 refers to the concealment management information 168 in which the concealment level is set in advance for the call functions and the like, thereby being capable of determining the concealment subject (524) of the cooperation request.

(3) In the server (161) according to Item (2), when the cooperation module (165) determines that the cooperation request is required to be concealed, the cooperation module (165) is configured to add, to the cooperation request, information indicating whether concealment of a response to the cooperation request is required, and to transmit the cooperation request.

With the above-mentioned configuration, the cooperation module 165 of the server 161 refers to the concealment management information (168) in which the content of the concealment is set in advance, thereby being capable of adding the information indicating whether the concealment of the response to the cooperation request is required. The response to the cooperation can be hidden from the computers 101 belonging to the blockchain BC #1 by concealing the response to the cooperation request.

(4) There is provided a data processing method for performing cooperation of processing in a computer system including a first computer (101) belonging to a first blockchain (BC #1), a second computer (121) belonging to a second blockchain (BC #2), and a server (161) coupled to the first computer (101) and the second computer (121) via a network (10), the data processing method including: a first step of receiving, by the server (161), a processing request; a second step of determining, by the server (161), whether the received processing request includes a cooperation request indicating processing to be applied to the first blockchain (BC #1) to which the first computer (101) belongs and processing to be applied to the second blockchain (BC #2) to which the second computer (121) cooperating with the first computer (101) belongs; a third step of determining, by the server (161), when the cooperation request is included in the processing request, whether concealment of the cooperation request is required; a fourth step of concealing, by the server (161), the cooperation request when the concealment is required based on a result of the determination; and a fifth step of transmitting, by the server (161), to the first computer (101), a processing execution request including the cooperation request which has been concealed in the fourth step in accordance with the result of the determination.

With the above-mentioned configuration, the data is shared among the computers 101 (first computers) belonging to the blockchain BC #1 of the cooperation source (first blockchain), and the information which is not relevant to the participants of the blockchain BC #1 of the cooperation source, or which is not intended to be disclosed thereto, such as the information (cooperation request and response) managed by the blockchain BC #2 (second blockchain), can be shared among only parties concerned through the concealment.

(5) In the data processing method according to Item (4), the server (161) further includes concealment management information (168) in which a content of the concealment is set in advance, and the fourth step includes determining a content of the concealment of the cooperation request based on the concealment management information (168).

With the above-mentioned configuration, the server 161 refers to the concealment management information 168 in which the concealment level is set in advance for the call function and the like, thereby being capable of determining the concealment subject (524) of the cooperation request.

(6) In the data processing method according to Item (5), the fifth step includes referring to the concealment management information when it is determined that the cooperation request is required to be concealed, adding, to the cooperation request, information indicating whether concealment of a response to the cooperation request is required, and transmitting the cooperation request.

With the above-mentioned configuration, the cooperation module 165 of the server 161 refers to the concealment management information 168 in which the content of the concealment is set in advance, thereby being capable of adding the information indicating whether not the concealment of the response to the cooperation request is required. The response to the cooperation request can be hidden from the computers 101 belonging to the blockchain BC #1 by concealing the response to the cooperation request.

(7) There is provided a computer system for performing cooperation of processing, the computer system including: a first computer (101) belonging to a first blockchain (BC #1); a second computer (121) belonging to a second blockchain (BC #2); and a server (161) coupled to the first computer (101) and the second computer (121) via a network, wherein the server (161) includes: a cooperation module (165) configured to receive a processing request, determine whether the processing request includes a cooperation request indicating processing to be applied to the first blockchain (BC #1) to which the first computer (101) belongs and processing to be applied to the second blockchain (BC #2) to which the second computer (121) cooperating with the first computer (101) belongs, and to determine whether concealment of the cooperation request is required when the cooperation request is included; and a concealment module (166) configured to conceal the cooperation request required to be concealed based on a result of the determination, and wherein the cooperation module (165) is configured to transmit, to the first computer (101), as a processing execution request, a processing request including the cooperation request which has been concealed by the concealment module (166) in accordance with the result of the determination.

With the above-mentioned configuration, the data is shared among the computers 101 (first computers) belonging to the blockchain BC #1 of the cooperation source (first blockchain), and the information which is not relevant to the participants of the blockchain BC #1 of the cooperation source, or which is not intended to be disclosed thereto, such as the information (cooperation request and response) managed by the blockchain BC #2 (second blockchain), can be shared among only parties concerned through the concealment.

(8) In the computer system according to Item (7), the server (161) further includes concealment management information (168) in which a content of the concealment is set in advance, and the cooperation module (165) is configured to determine a content of the concealment of the cooperation request based on the concealment management information (168).

With the above-mentioned configuration, the data concealment module 166 of the server 161 refers to the concealment management information 168 in which the concealment level is set in advance for the call function and the like, thereby being capable of determining the concealment subject (524) of the cooperation request.

(9) In the computer system according to Item (7), when the cooperation module (165) determines that the cooperation request is required to be concealed, the cooperation module (165) is configured to refer to the concealment management information (168), add, to the cooperation request, information indicating whether concealment of a response to the cooperation request is required, and to transmit the cooperation request.

With the above-mentioned configuration, the cooperation module 165 of the server 161 refers to the concealment management information (168) in which the content of the concealment is set in advance, thereby being capable of adding the information indicating whether the concealment of the response to the cooperation request is required. The response to the cooperation can be hidden from the computers 101 belonging to the blockchain BC #1 by concealing the response to the cooperation request.

(10) In the computer system according to Item (7), the first computer (101) is configured to receive the processing execution request from the server (161), process the processing request included in the processing execution request, and to transmit the cooperation request to the second computer (121) when the processing execution request includes the cooperation request, the second computer (121) is configured to receive the cooperation request, restore the cooperation request and then process the cooperation request when the cooperation request has been concealed, and to return a processing result of the cooperation request to the first computer (101) as a response, and the first computer (101) is configured to return, when the response to the cooperation request is received, a processing result of the processing request and the processing result of the cooperation request to the server (161) as a response.

With the above-mentioned configuration, the computer 121 belonging to the blockchain BC #2 (second blockchain) conceals the response to the cooperation request, thereby being capable of hiding the response to the cooperation request from the computers 101 belonging to the blockchain BC #1.

(11) There is provided a computer (121) including: a processor (CPU 123); a memory (122); an interface (124) coupled to a first computer (101); a cooperation module (125) configured to receive a cooperation request, and to determine whether the cooperation request has been concealed; a restoration module (concealment restoration module 129) configured to restore the cooperation request when the cooperation request has been concealed; and a management module (transaction management module 126) configured to process the restored cooperation request, wherein the cooperation module (125) is configured to return a result of the processing as a response.

The computer 121 (second computer) can restore (decrypt) the concealed cooperation request, process the restored cooperation request in the transaction management module 126, and return the processing result of the cooperation request as a response while the cooperation request is hidden from the computers 101.

(12) The computer (121) according to Item (11) further includes: concealment level management information (concealment control information 130) in which whether concealment of a content of the response is required is set in advance; and a concealment module (data concealment module 128) configured to conceal a processing result obtained by the management module (126) based on the concealment level management information (130), and the cooperation module (125) is configured to return the concealed processing result as a response.

With the above-mentioned configuration, the computer 121 belonging to the blockchain BC #2 (second blockchain) conceals the response to the cooperation request, thereby being capable of hiding the response to the cooperation request from the computers 101 belonging to the blockchain BC #1.

(13) In the computer according to Item (12), the concealment module (128) is configured to determine a content of the concealment of the processing result based on the concealment level management information (130).

With the above-mentioned configuration, the computer 121 belonging to the blockchain BC #2 (second blockchain) refers to the concealment control information 130, thereby being capable of controlling whether the response to the cooperation request is concealed.

This invention is not limited to the embodiments described above, and encompasses various modification examples. For instance, the embodiments are described in detail for easier understanding of this invention, and this invention is not limited to modes that have all of the described components. Some components of one embodiment can be replaced with components of another embodiment, and components of one embodiment may be added to components of another embodiment. In each embodiment, other components may be added to, deleted from, or replace some components of the embodiment, and the addition, deletion, and the replacement may be applied alone or in combination.

Some of all of the components, functions, processing units, and processing means described above may be implemented by hardware by, for example, designing the components, the functions, and the like as an integrated circuit. The components, functions, and the like described above may also be implemented by software by a processor interpreting and executing programs that implement their respective functions.

Programs, tables, files, and other types of information for implementing the functions can be put in a memory, in a storage apparatus such as a hard disk, or a solid state drive (SSD), or on a recording medium such as an IC card, an SD card, or a DVD.

The control lines and information lines described are lines that are deemed necessary for the description of this invention, and not all of control lines and information lines of a product are mentioned. In actuality, it can be considered that almost all components are coupled to one another.

### <Supplement>

Representative aspects of this invention other than those described in the appended claims include the following.

<14>

A first computer, including:

a processor;

a memory;

an interface coupled to a server and a second computer;

a cooperation module configured to receive a processing execution request from the server, determine whether a cooperation request is included in the processing execution request, and to transmit the cooperation request to the second computer when the cooperation request is included; and

a management module configured to process a processing request included in the processing execution request,

wherein the cooperation module is configured to return, when the cooperation module receives a processing result of the cooperation request from the second computer, a processing result of the processing request and the processing result of the cooperation request to the server as a response.

<15>

A data processing method for performing cooperation of processing by a first computer including a processor, a memory, and an interface coupled to a server and a second computer, the data processing method including:

a first step of receiving, by the first computer, a processing execution request from the server, determining whether a cooperation request is included in the processing execution request, and transmitting the cooperation request to the second computer when the cooperation request is included;

a second step of processing, by the first computer, a processing request included in the processing execution request; and

a third step of returning, by the first computer, when a processing result of the cooperation request is received from the second computer, a processing result of the processing request and the processing result of the cooperation request to the server as a response.

<16>

A data processing method for performing cooperation of processing by a second computer including a processor, a memory, and an interface coupled to a first computer, the data processing method including:

a cooperation module configured to receive a cooperation request, and to determine whether the cooperation request has been concealed;

a restoration module configured to restore the cooperation request when the cooperation request has been concealed; and

a management module configured to process the restored cooperation request,

wherein the cooperation module is configured to return a processing result obtained by the management module as a response.

<17>

The data processing method according to Item <16>, further including:

concealment level management information in which whether concealment of a content of the response is required is set in advance; and

a concealment module configured to conceal the processing result obtained by the management module based on the concealment level management information,

wherein the cooperation module is configured to return the concealed processing result as a response.

<18>

The data processing method according to Item <17>, wherein the concealment module is configured to determine a content of the concealment of the processing result based on the concealment level management information.

<19>

A data processing method for performing cooperation of processing by a server including a processor, a memory, and an interface coupled to a first computer, the data processing method including:

a first step of receiving, by the server, a processing request, determining whether the processing request includes a cooperation request indicating processing to be applied to a first blockchain to which the first computer belongs and processing to be applied to a second blockchain to which a second computer cooperating with the first computer belongs, and determining whether concealment of the cooperation request is required when the cooperation request is included;

a second step of concealing, by the server, the cooperation request required to be concealed based on a result of the determination; and

a third step of transmitting, by the server, to the first computer, a processing execution request including the cooperation request which has been concealed in the second step in accordance with the result of the determination.

<20>

The data processing method according to Item <19>,

wherein the server further includes concealment management information in which a content of the concealment is set in advance, and

wherein the second step includes determining a content of the concealment of the cooperation request based on the concealment management information.

<21>

The data processing method according to Item <19>, wherein the second step includes adding, when it is determined that the cooperation request is required to be concealed, information indicating whether concealment of a response to the cooperation request is required to the cooperation request, and transmitting the cooperation request.

1. A server, comprising:
a processor;
a memory;
an interface coupled to a first computer;
a cooperation module configured to receive a processing request, determine whether the processing request includes a cooperation request indicating processing to be applied to a first blockchain to which the first computer belongs and processing to be applied to a second blockchain to which a second computer cooperating with the first computer belongs, and to determine whether concealment of the cooperation request is required when the cooperation request is included; and
a concealment module configured to conceal the cooperation request required to be concealed based on a result of the determination,
wherein the cooperation module is configured to transmit, to the first computer, a processing execution request including the cooperation request which has been concealed by the concealment module in accordance with the result of the determination.

2. The server according to claim 1, further comprising concealment management information in which a content of the concealment is set in advance,
wherein the concealment module is configured to determine a content of the concealment of the cooperation request based on the concealment management information.

3. The server according to claim 2, wherein, when the cooperation module determines that the cooperation request is required to be concealed, the cooperation module is configured to refer to the concealment management information, add, to the cooperation request, information indicating whether concealment of a response to the cooperation request is required, and to transmit the cooperation request.

4. A data processing method for performing cooperation of processing in a computer system comprising a first computer belonging to a first blockchain, a second computer belonging to a second blockchain, and a server coupled to the first computer and the second computer via a network, the data processing method comprising:
a first step of receiving, by the server, a processing request;
a second step of determining, by the server, whether the received processing request includes a cooperation request indicating processing to be applied to the first blockchain to which the first computer belongs and processing to be applied to the second blockchain to which the second computer cooperating with the first computer belongs;
a third step of determining, by the server, when the cooperation request is included in the processing request, whether concealment of the cooperation request is required;
a fourth step of concealing, by the server, the cooperation request when the concealment is required based on a result of the determination; and
a fifth step of transmitting, by the server, to the first computer, a processing execution request including the cooperation request which has been concealed in accordance with the result of the determination.

5. The data processing method according to claim 4,
wherein the server further comprises concealment management information in which a content of the concealment is set in advance, and
wherein the fourth step comprises determining a content of the concealment of the cooperation request based on the concealment management information.

6. The data processing method according to claim 5, wherein the fifth step comprises referring to the concealment management information when it is determined that the cooperation request is required to be concealed, adding, to the cooperation request, information indicating whether concealment of a response to the cooperation request is required, and transmitting the cooperation request.

7. A computer system for performing cooperation of processing, the computer system comprising:
a first computer belonging to a first blockchain;
a second computer belonging to a second blockchain; and
a server coupled to the first computer and the second computer via a network,
wherein the server comprises:
a cooperation module configured to receive a processing request, determine whether the processing request includes a cooperation request indicating processing to be applied to the first blockchain to which the first computer belongs and processing to be applied to the second blockchain to which the second computer cooperating with the first computer belongs, and to determine whether concealment of the cooperation request is required when the cooperation request is included; and
a concealment module configured to conceal the cooperation request required to be concealed based on a result of the determination, and
wherein the cooperation module is configured to transmit, to the first computer, as a processing execution request, a processing request including the cooperation request which has been concealed by the concealment module in accordance with the result of the determination.

8. The computer system according to claim 7,
wherein the server further comprises concealment management information in which a content of the concealment is set in advance, and
wherein the cooperation module is configured to determine a content of the concealment of the cooperation request based on the concealment management information.

9. The computer system according to claim 8, wherein, when the cooperation module determines that the cooperation request is required to be concealed, the cooperation module is configured to refer to the concealment management information, add, to the cooperation request, information indicating whether concealment of a response to the cooperation request is required, and to transmit the cooperation request.

10. The computer system according to claim 7,
wherein the first computer is configured to receive the processing execution request from the server, process the processing request included in the processing execution request, and to transmit the cooperation request to the second computer when the processing execution request includes the cooperation request,
wherein the second computer is configured to receive the cooperation request, restore the cooperation request and then process the cooperation request when the cooperation request has been concealed, and to return a processing result of the cooperation request to the first computer as a response, and
wherein the first computer is configured to return, when the response to the cooperation request is received, a processing result of the processing request and the processing result of the cooperation request to the server as a response.

11. A computer, comprising:
a processor;
a memory;
an interface coupled to a first computer belonging to a first blockchain;
a cooperation module configured to receive a cooperation request including processing to be applied to a second blockchain to which the computer belongs, and to determine whether the cooperation request has been concealed;
a restoration module configured to restore the cooperation request when the cooperation request has been concealed; and
a management module configured to process the restored cooperation request,
wherein the cooperation module is configured to return a result of the processing as a response,
wherein the cooperation request includes processing to be applied to the second blockchain that cooperates with the processing to be applied to the first blockchain.

12. The computer according to claim 11, further comprising:
concealment level management information in which whether concealment of a content of the response is required is set in advance; and
a concealment module configured to conceal a processing result obtained by the management module based on the concealment level management information,
wherein the cooperation module is configured to return the concealed processing result as a response.

13. The computer according to claim 12, wherein the concealment module is configured to determine a content of the concealment of the processing result based on the concealment level management information.
